(19) United States
(12) Patent Application Publication
(10) Pub. No.: US 2005/0185808 A1
(43) Pub. Date: Aug. 25, 2005

(54) Composite structure with push-pull unit speakers

(75) Inventor: Yueh-Hua Hsu Huang, Chung-Ho City (TW)

Correspondence Address: BACON & THOMAS, PLLC, 625 SLATERS LANE, FOURTH FLOOR, ALEXANDRIA, VA, 22314, US

(73) Assignee: JAZZ HIPSTER CORPORATION, CHUNG-HO City (TW)

(21) Appl. No.: 10/780,727

(22) Filed: Feb. 19, 2004

(51) Int. Cl. H04R 25/00; H04R 1/02; H04R 1/20

(52) U.S. Cl. 381/182; 381/338; 381/337; 381/345

(57) ABSTRACT

This invention provides a designed structure with push-pull unit speakers, mainly, one or more than one magnet assembly structure additionally being provided between the two unit speakers located in the current sound box so that the magnetic structure and the electromagnetic structure, although both being close together, are made to be repulsive to each other; thereby a push-pull action resulting in all the formed magnetic fields after the current is ON may be used to solve the problem of the speaker in instability and distortion at low frequency for further exaltation of the power bearable by speaker and the efficiency without any limit of sound box or other aspects.

### FIELD OF THE INVENTION

This invention relates to an improved structure with a unit speaker and, in a specific way, particularly to a composite structure with push-pull unit speakers designed with one or more than one magnet additionally provided between two unit speakers in a current sound box; the added magnet structure and the mutual push-pull action formed in the existing magnetic field help the unit speaker to be stable at a low frequency, and boost the sound pressure, power it bears, and efficiency.

### BACKGROUND OF THE INVENTION

According to the conventional unit speaker structure, as seen in FIGS. 1 and 2, two unit speaks independently functioning are provided in the sound box, and thereby, when they are used, a signal from an amplifier is sent to the speakers, and after the signal passes a tone separator and is filtered, it is sent to each unit. Transmitted through air and refracted and diffracted in a room, the possessive tone from the unit becomes the sound that we hear.

However, the great majority who have designed the speaker system know that the specifications of unit speaker are the source data necessary, especially those of bass unit that are essential to the volume of sound box. Certainly, treble and mediant units must also be considered, but they are not more complicated than the bass unit.

The quality of a speaker mostly depends on “unit”, namely a basin-shaped membrane on the speaker. Theoretically, the more big the unit becomes, the more wide its frequency response results; at the bass segment, it is more natural and powerful but somewhat turbid at the treble segment, and relatively a small unit performs for treble. Here, the quality of the designed circuit works on the timbre and entire performance of the speaker, and the speaker functions to give the small unit an audio signal at a high frequency and contrarily to give the bigger unit that at a low frequency. Hence, the currently familiar unit speaker cannot break the limit of sound box so as not to magnify the magnet efficiency at a better low frequency and obviously cannot bear enough the power and work efficiently.

From the foregoing conventional structure with the unit speaker, although a most standard sound amplification function may be provided, it is obviously poor for the user to request a higher class of timbre or tone classification; especially for the user to run to be in the fashion, if the added value of a trade article on the same level does not keeps higher, it is obvious that the goods are difficult to meet the request of the modern people for a novel product.

Consequently, to promote a product, design and development should be implemented for high practicality and worth, so the object of this invention is to develop an excellent, remarkable product insinuating itself into the good graces of customers.

For this reason, considering the above-mentioned conventional structure with unit speakers, this inventor moreover designed and aggressively improved the limit of bearable power and efficiency in the sound box of fixed size, and the distortion phenomenon happening at a low frequency, and finally succeeded in this invention through unceasing diligent trial.

### SUMMARY OF THE INVENTION

The object of this invention is mainly to provide a structure with push-pull unit speakers so as to refrain from distortion of the speaker at low frequency, to enhance speaker's stability, and to increase the sound pressure, power bearable by speaker, and efficiency.

According to the foregoing object of this invention, each of the structure with push-pull unit speakers is mainly provided with a electromagnetism structure, a model of N/S and a model of S/N, separately formed in the two unit speakers in the sound box, and is further provided with one or more than one magnetic assembly structure and pushes the polarities of both ends of the magnetic structure to be separately repulsive from the polarities of the two electromagnetism structures so that a mutual push-pull action is caused between the respective unit magnetic field because of the action of magnetic field resulting from one or more than one magnets added, for the purpose of improvement of and solution to instability and distortion at the time of use of the unit speakers at low frequency.

For you examinator to further realize the features and effects of the structure of this invention, the preferred embodiments are in detail given below accompanying with figures.

### BRIEF DESCRIPTION OF THE DRAWINGS

FIG. 1 is a 3D perspective view of a structure with conventional unit speakers.

FIG. 2 is a schematic plan view of the structure with conventional unit speakers.

FIG. 3 is a 3D perspective view according to a preferred embodiment of this invention.

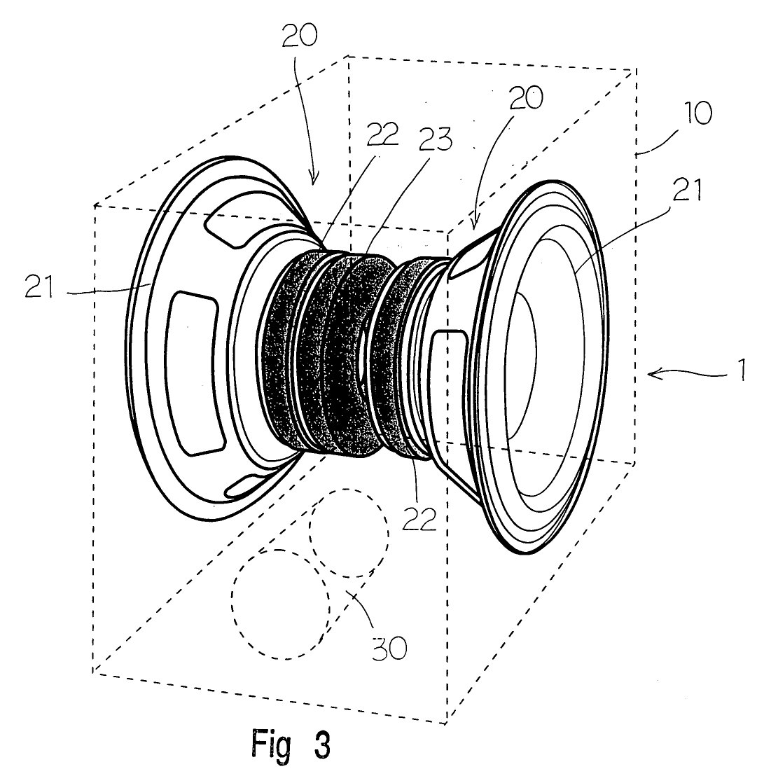

FIG. 4 is a schematic plan view according to a preferred embodiment of this invention.

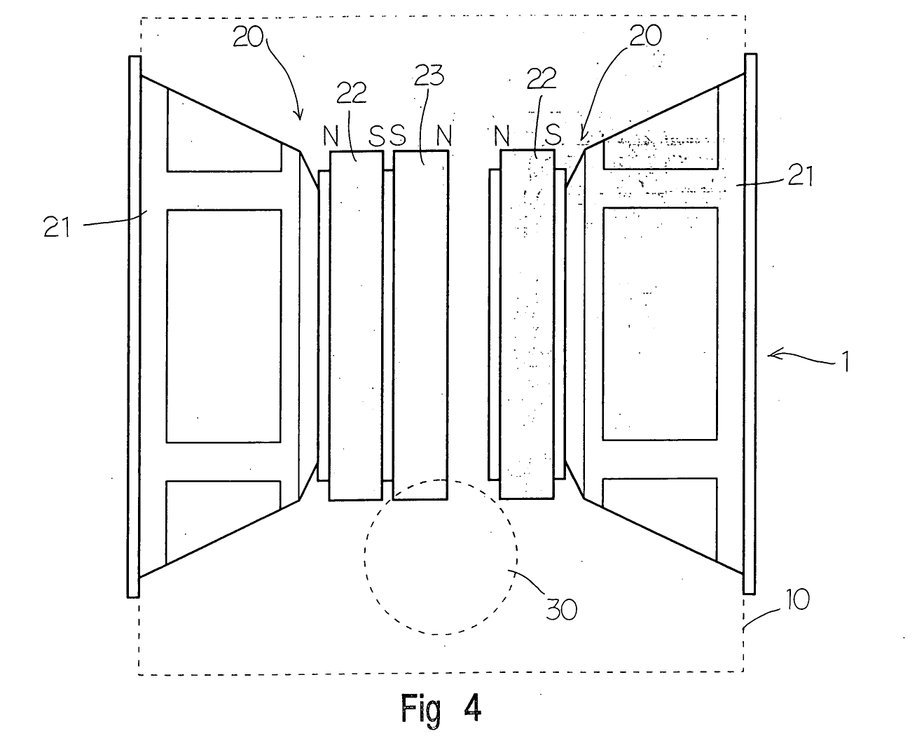

FIG. 5 is a 3D perspective view according to a preferred embodiment of this invention.

FIG. 6 is a schematic plan view according to a preferred embodiment of this invention.

FIG. 7 shows a sound pressure test curve chart describing a conventional unit speaker.

FIG. 8 shows a sound pressure test curve chart describing a push-pull unit speaker.

FIG. 9 is a distortion curve chart describing the unit speaker at low frequency.

FIG. 10 shows a distortion curve chart describing the push-pull unit speaker according this invention at low frequency.

### DETAILED DESCRIPTION OF THE INVENTION

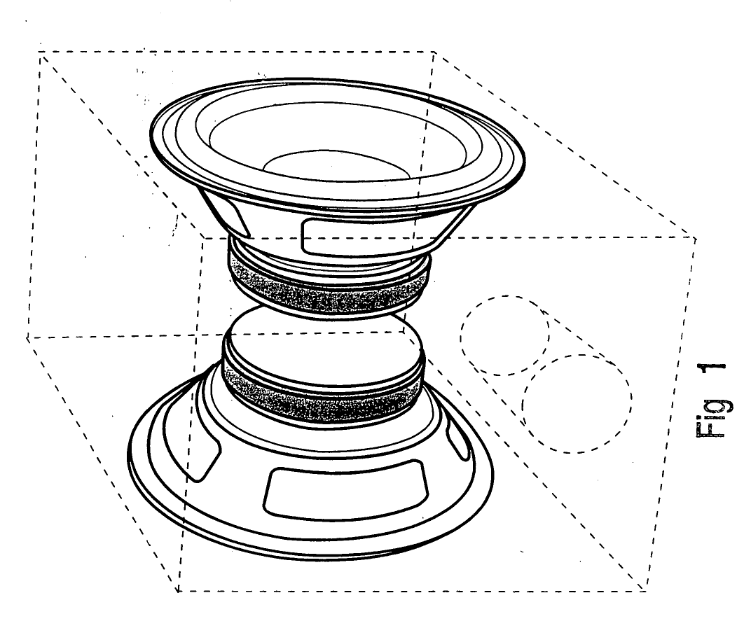

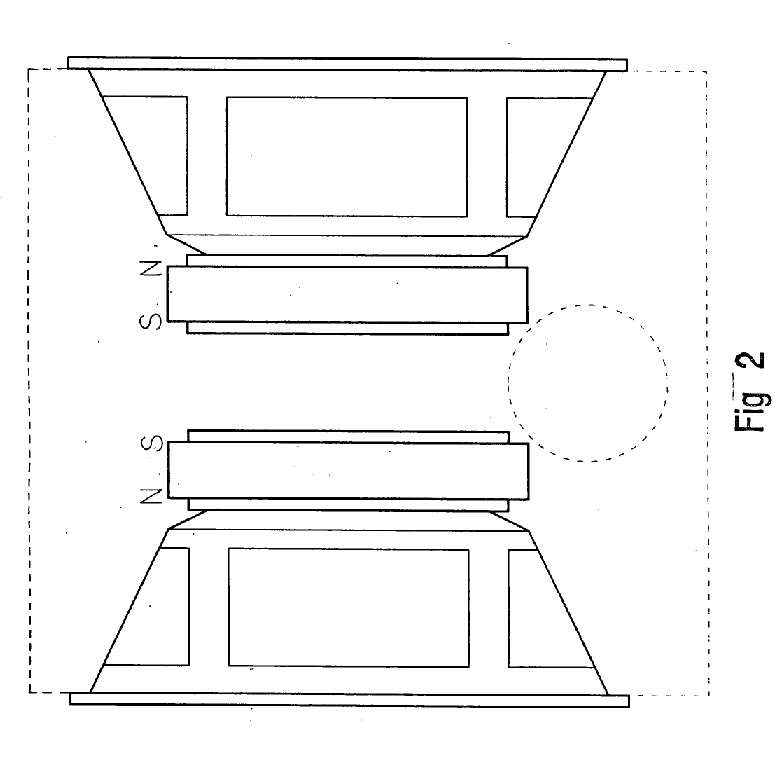

This invention provides a structure with push-pull unit structures different from the well known sound box; as seen in FIGS. 1 and 2, the designed structure (1) with push-pull unit speakers is generally made up with a sound box (10), two unit speakers (20), and more than one echo pipe (30), in which the sound box (10) may be a hollow, airtight model of any form, two unit speakers (20) of twin sound channels and partially related components and fittings may be provided inside the box, and a sound-uttered hole and an outgoing line hole are given outside the box, releasing the sound through the unit speaker (20) and functioning by connecting with power supply.

Two unit speakers (20) according to this invention are located opposite to each other, and the front end of each unit speaker (20) is provided with a light, rigid, thin basin-shaped membrane (21), made of rubber, paper, metal, ceramics or the like, for sound utterance through resonance; the back end far from the basin-shaped membrane (21) is provided with an electromagnetism structure (22), while the polarities of the electromagnetism structure (22) of the two unit speakers (20) are N/S and S/N, respectively; an extra magnetic structure (23) is located between the two unit speakers (20), and such a magnetic structure (23) is associated with the magnetic structure (23) of one of the unit speakers (20) to shorten the distance from the magnetic structure (22) of the other unit speaker (20) and to make the polarities of the two ends of the magnetic structure (23) be repulsive, thereby a push-pull action resulting in all the formed magnetic fields after the current is ON.

More than one echo pipe (30) may, depending on the need, be optionally provided under the two unit speakers (20) inside the sound box (10) for achievement of the compass expanding and for realization of the sufficient dynamics and the bass stretching enough low at low frequency.

Through the foregoing units, the complete structure with push-pull unit speakers according to this invention is established.

According to the structure with push-pull unit speakers which are practically used, when the current passes through the electromagnetism structure (22) of each of the unit speakers (20), galvanomagnetic effect happens and further galvanomagnetic effect (23) results in the magnetic structure linked with the back of an additional electromagnetism structure (22), thereby the mutual push-pull action being caused between the magnetic fields because the polarities are repulsive to each other; the push-and-pull action of so close quarters will improve the operation mode of each of the unit speakers without galvanomagnetic effect due to excessive distance, virtually the unit speakers being made to lift the stability of its resonance frequency at low frequency for decrease of distortion.

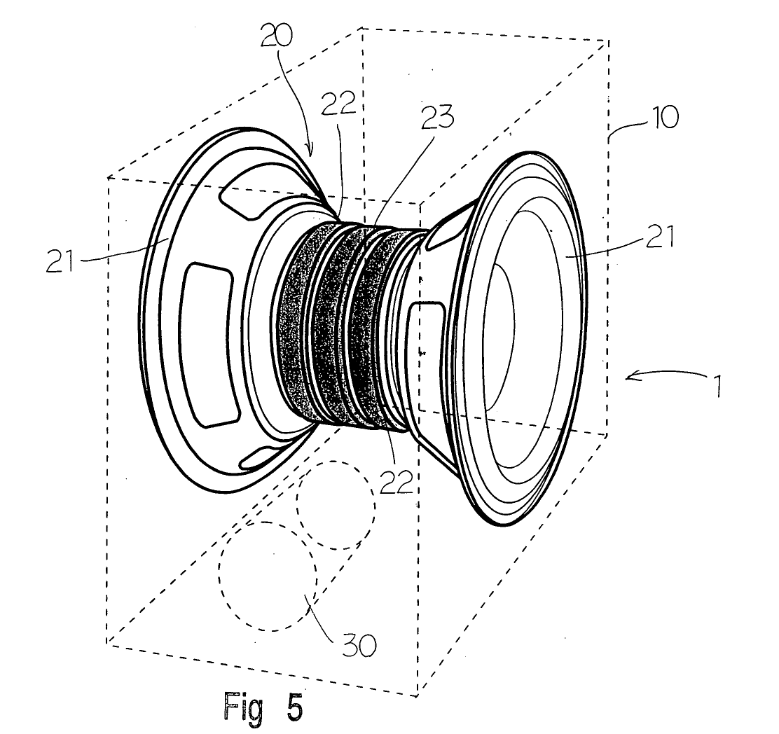

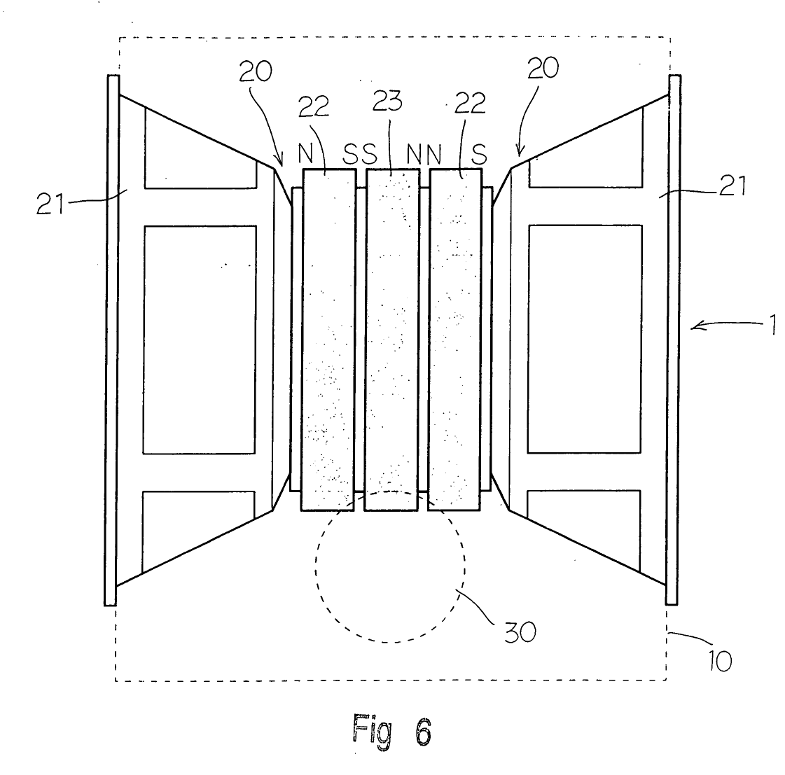

Further, to solve the interference in the magnetic field of the two conventional unit speakers (20), improvement of the magnetic-field push-pull action according to this invention; in addition to a magnetic structure (23) connected with the back of the electromagnetism structure (22) of one of the unit speakers (20) described above so as to shorten the distance between the two unit speakers (20) for achievement of the magnetic-field push-pull effect, the extra magnetic structure (23) between the two unit speakers (20) may still be connected with it, as shown in FIGS. 5 and 6, the magnetic-field push-pull effect caused being more obvious at the condition of no distance from each other.

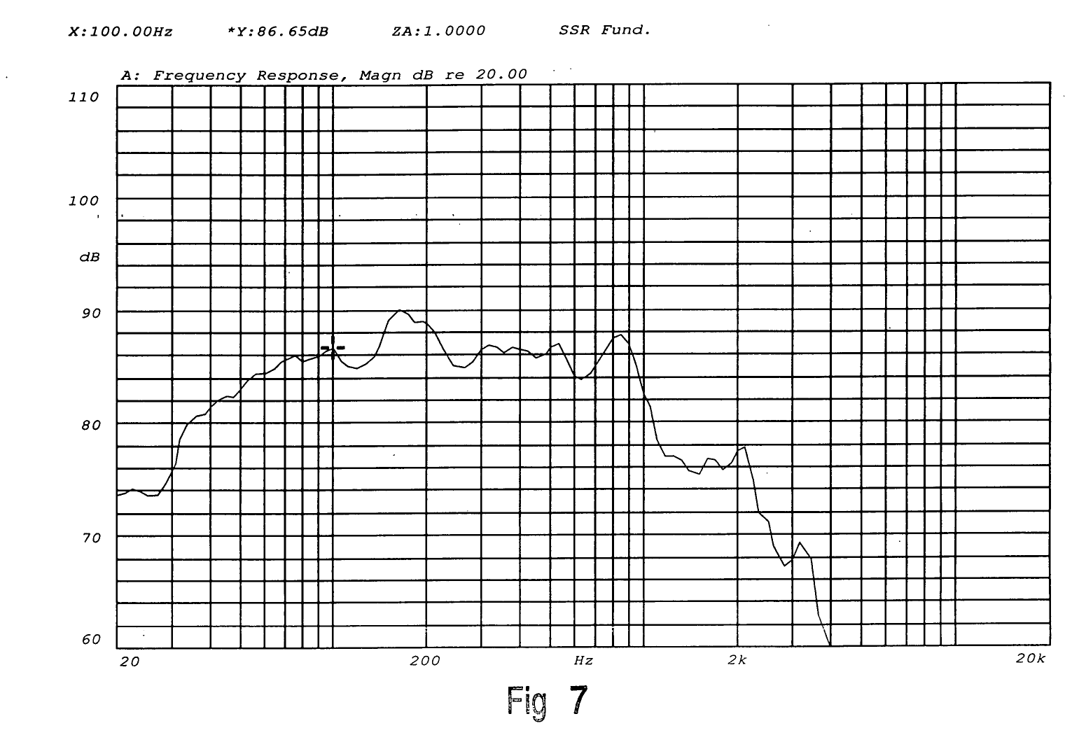

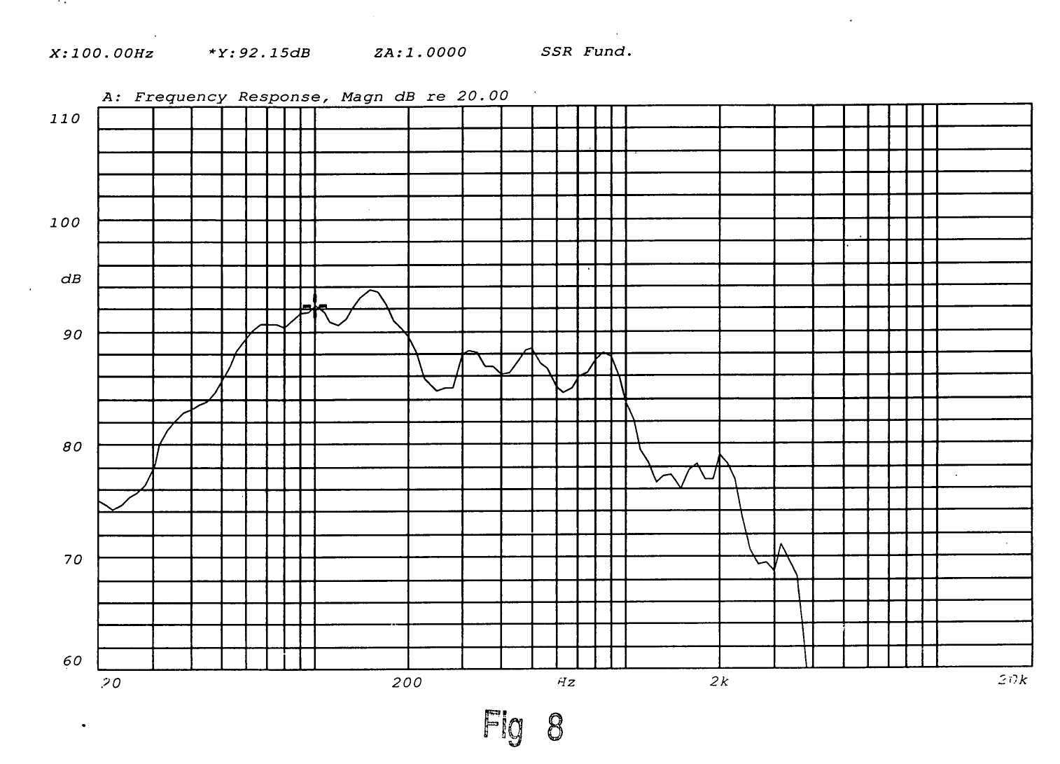

Referring to FIGS. 7 and 8, a sound pressure curve chart describing the conventional unit speaker and that describing this invention are respectively shown; through comparison of the two charts, it is obviously seen that when a magnetic structure is added and the unit speaker is made to completely be at low frequency, the range of the audio frequency will tent to become level.

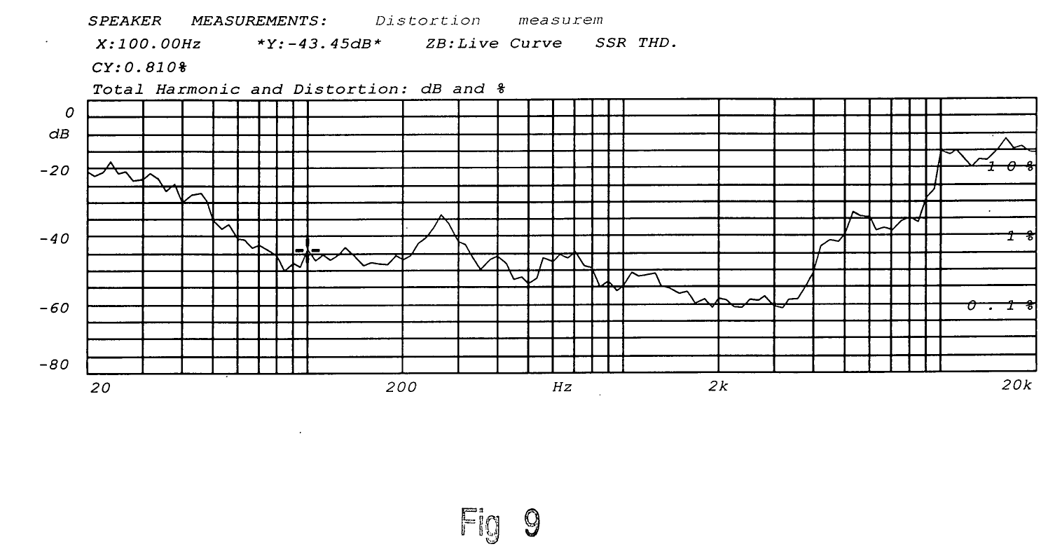

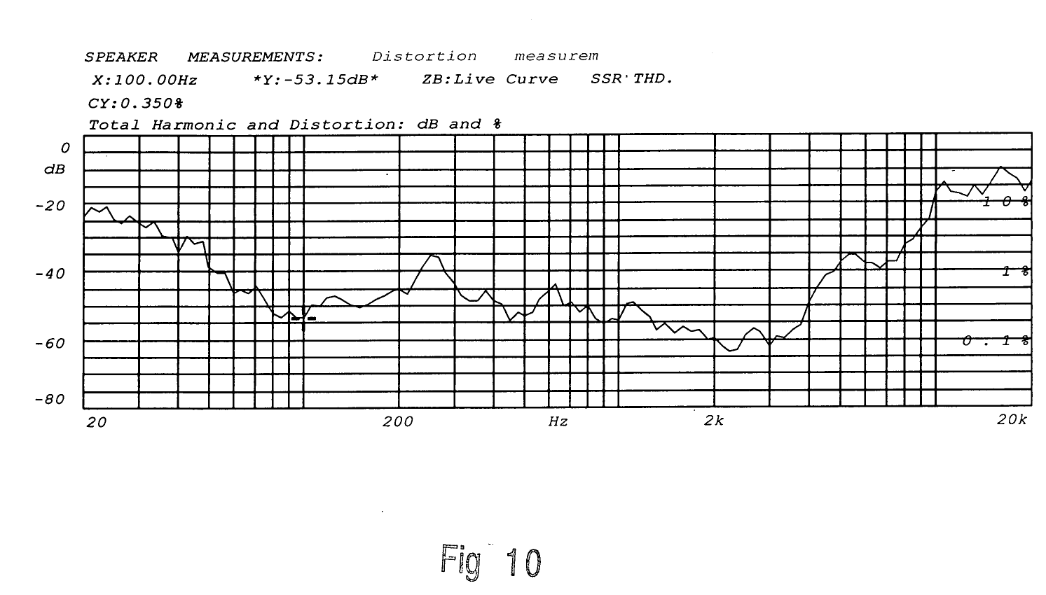

Further referring to FIGS. 9 and 10, a distortion curve chart describing the conventional unit speaker and that describing this invention both at low frequency are respectively shown; from the two charts, it is given that the wave crest according to this invention is low and small, properly indicating that its distortion is lower and the present timbre is also preferable; on the contrary, more wave crests are generated from the conventional unit speaker and distortion is higher, so the timbre is surely unclear.

To sum up, through the structure with push-pull unit speakers creatively designed by this inventor so as to properly improve the operation mode of each of the unit speakers without galvanomagnetic effect due to excessive distance, virtually the unit speakers is made to lift the stability of its resonance frequency at low frequency for decrease of distortion and further to increase the power bearable by unit speaker and the efficiency; also, thanks to no enclosure of the products similar to this invention, such a claim should be legally laid for a new model patent.

1. A structure with push-pull unit speakers generally comprising a sound box, two unit speakers, and an echo pipe, which is characterized that
the magnetic poles of the electromagnetism structure of the two unit speakers are respectively formed with N/S and S/N, between which a magnetic structure is provided connecting with the electromagnetism structure of one of the unit speakers, and further the polarities of the two ends of the magnetic structure is made to be repulsive to the polarities of the foregoing two electromagnetism structures, respectively; by a mutual push-pull action in the magnetic fields from the added magnets after electric conduction, distortion of the speaker is solved; in the mean time stability may also be enhanced at low frequency, and the sound pressure and the efficiency and power bearable by speaker are increased.

2. The structure with push-pull unit speakers of claim 1, in which the added magnetic structures may be separately connected with the electromagnetism structures of the two unit speakers.
